(19) United States
(12) Patent Application Publication
(10) Pub. No.: US 2009/0097825 A1
(43) Pub. Date: Apr. 16, 2009

(54) Peer to Peer Distribution of Media Files

(76) Inventor: Scott C. Harris, Rancho Santa Fe, CA (US)

Correspondence Address: SCOTT C HARRIS, P O BOX 927649, SAN DIEGO, CA, 92192, US

(21) Appl. No.: 11/381,800

(22) Filed: May 5, 2006

(51) Int. Cl. H04N 7/26; G06F 15/16

(52) U.S. Cl. 386/124; 709/231; 386/E05.001

(57) ABSTRACT

A DVR that allows peer to peer streaming of video information. The information can be based on a subscription, and can be charged a fee based on the ratio of uploading to downloading.

### BACKGROUND

Peer-to-peer systems are known in which each of a plurality of peers shares files from its own file system with other peers. The system works best when each of the plurality of peers allows uploading of file information and downloading of file information. For example, one peer (peer A) may have certain files in its associated memory that are desired by another peer, peer B. Peer A may desire files from Peer C. As long as all the peers communicate with each other and give about as much file content as they receive, the system works quite well as a file sharing utility.

Peer-to-peer systems have conventionally been used in computers. When monitoring the peer actions, a value called the ratio, or U/D ratio, has been used. The ratio measures the relationship between the amount of information that the peer has downloaded, and the amount of information that the peer has uploaded. Peers that download too many files are called leechers. A desired ratio is one to one, this will ensure that the peer-to-peer system always operates the way it should. However, it is inevitable that some leechers will always exist.

### SUMMARY

The present application teaches use of a peer-to-peer system for distributing certain kinds of media. One aspect describes distributing the media on a subscription basis. Another aspect describes a peer-to-peer system being used between different digital video recorder systems such as “TiVo”s for a built-in system of this type. Another aspect describes the way that the peer-to-peer operation is billed.

### BRIEF DESCRIPTION OF THE DRAWINGS

These and other aspects will now be described in detail with reference to the accompanying drawings wherein:

FIG. 1 shows a block diagram of the peer-to-peer system between different peers and a central database; and

FIG. 2 illustrates a flowchart of operation of the system.

### DETAILED DESCRIPTION

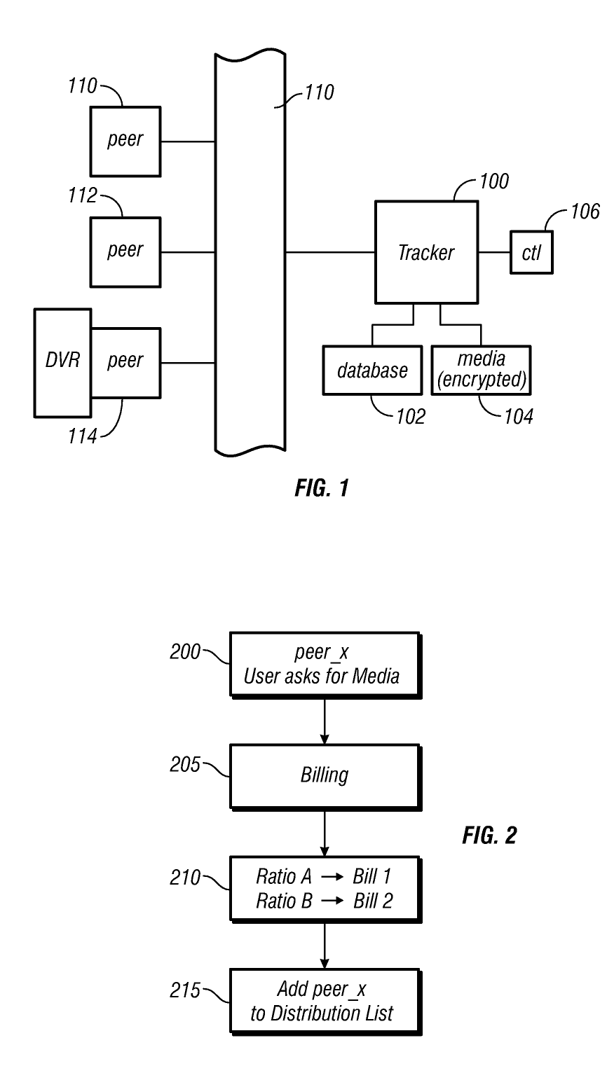

FIG. 1 shows a block diagram of operation. This brings together a number of technologies in a new way in which they have not previously been combined.

Conventional digital video recorders must contact a central database in order to get programming information. For example, recorders such as the TiVo series 2 can contact the database via a telephone line or via an ethernet connection which is typically through a high speed conduit such as a cable modem or DSL. Because of this, the digital video recorders have network capabilities. Technologies such as “Tivo-to-go” can allow the content on the DVR to be transferred to either another DVR, or to a computer.

Add to this another very different technology: the technology of distributing videos for rent through the mail. Many different services, such as Netflix, Blockbuster online, and others enable distribution of videos by mail. The user is mailed the video, watches the video, and returns it. The longest delay in this system, however, is often mailing. Therefore, users often require multiple different videos at one time, mostly so that they have some videos while they are waiting for the mailing delays.

According to an embodiment, a media distribution system uses a peer-to-peer network to distribute media to a computer. In the embodiment shown in FIG. 1, a “tracker” 100 is connected to the Internet 110. The tracker referees between the peers. There may be hundreds, thousands, or even millions of peers. The tracker monitors which peer is requesting information, and which peer gets information. A peer-to-peer system usually works by one peer asking for a file piece from any other peer. Any other peer who has that piece responds and provides the piece. Since all of the peers are continually exchanging pieces, the peers eventually end up with multiple copies of the same information. One or more “seeders” may initiate the file transfer. Once started, the file transfer continues basically indefinitely.

The tracker may do many things, including, monitor who is asking for pieces and who is getting pieces and sending pieces. The tracker relies on the database 102, which keeps track of which peer got what amount, and possible what file piece. The data is used to determine the ratio between files downloaded and files uploaded. A distributed database technology is also known, in which each peer maintains a piece of the tracker.

Each of the peers shown in FIG. 1, specifically peers 110, 112 and 114, exchange file parts over the Internet. The file parts are from the media store 104 which stores the media that is distributed to the tracker. Tracker 100 monitors all of the file transfers, and only allows file transfers once a peer has properly been recognized and authenticated.

In the embodiment, an existing peer to peer system, such as “Bittorent”, or other system of this type, may be used.

According to this embodiment, different subscription plans are contemplated. Some subscription plans may allow an unlimited amount of data, while other subscription plans will allow only certain amounts of download in a specified period. According to one subscription plan, the amount that the user pays for will depend on the user's ratio. Therefore, if the peer has a ratio of 0.5, the peer might be charged five dollars for one piece of media or $25 per month. For example, the media is being distributed among the peers, and the tracker allows any peer access to that media after the price has been paid. At a different ratio, for example here who has a ratio of 1:1, may be charged three dollars for an item of media, or $20 per month. In this way, the users are effectively paid for agreeing to contribute to the peer-to-peer operation.

The flowchart in FIG. 2 illustrates the process. At 200, peer number x asks for a specified media which is present in the database 104. Presumably, the specified media is already being distributed among multiple peers in the system, or it may still be being seeded from the database. At 205, the request causes a billing routine to be executed by the controller 106 which is associated with the tracker. The controller 106 determines the peer's ratio, and sets and/or determines, the billing. For example, if the peer has a ratio in the range of A, the peer receives a billing amount number 1. If the peer has ratio B, the peer gets the billing amount number 2. The billing may be periodic, e.g., monthly, in which case this determination is simply whether the bill has been properly paid.

Once a peer is authenticated, information indicative of that peer and that file is stored, e.g., the IP address or “name” of the peer, and the file.

Once the peer has been authenticated, it is added to the distribution lists, which allows the tracker to start assigning pieces to the peer.

Note that the above billing technique may be used, or alternatively, a system may be used in which an unlimited plan is available, so the user is billed one amount as long as they keep their peer ratio over a certain amount, or billed a different amount per month if they allow their ratio to dip below that level. The ratios may be reset according to a sliding scale, or may be reset once a month.

An alternative billing system is also possible, in which the users simply pay a fixed amount.

According to one particularly preferred embodiment, at least one of the peers, such as 114, is actually a digital video recorder. The digital video recorder 114, for example, is a video recorder which has Internet access, and carries out a peer-to-peer operation. Exemplary DVRs include the Tivo units, e.g., the series 2, or basically any device that receives streamed or piecemeal content indicative of a media file, and stores it digitally for later playback. The file may be stored as compressed media, e.g., as MPEG, MPEG2, MP4, divx or Xvid, or any other compressed format.

Different parts of the file are exchanged with other peers (presumably other video recorders or computers) and when the media file is complete, it is stored on the hard drive of the DVR. The user can thereafter play the file from the hard drive of the DVR, allowing pause, stop and fast forward, or reverse, as conventional in DVRs functions. After the user completes the download of the file, the user can delete the file. Many DVR's have a recycle bin in which the deleted files are maintained so long as there is room on the hard drive. While in the recycle bin, the contents of the file can still be used for peer-to-peer operations.

The storage unit of the DVR, which stores information of upcoming programs, and program information, may also store the lists of peer to peer files that can be obtained. Alternatively, the DVR may access a dynamic list, e.g. a web site that shows a list of the files that can be obtained by peer to peer. The user may select any of the files from that list

Another aspect is that the DVR may automatically flag the files which are received by peer-to-peer operations, as compared with those that have been recorded in the conventional way (airwaves, cable, satellite, etc) as being “undeletable until played once”. The DVRs conventionally delete the oldest files when new files are recorded. An undeletable until played once flag prevents the downloaded file, which is downloaded responsive to a subscription, from being deleted until played. Another flag may be “delete within 24 hours” or some other time limit, which allows the DVR to store the media only for a specified amount of time. This could be used for pay per view or other first run type scenarios.

Conventional DVRs include analogous flags, such as “ok to delete after (date), or do not delete. This undeletable until played once flag may also be used for conventional DVR recorded programs.

The media which is stored and distributed may be conventional media, or may have some kind of encryption key associated therewith or include some other kind of security. The security may allow the file to be played once, or may prevent copying of the file, or some other limit on the file. Various different kinds of authoring protection schemes, including the Windows authoring protection scheme, could be used in this way. The file is sent to a computer could thus be prevented from being used as a bootleg copy of the media.

The security module may prevent certain actions from being taken on the peer-to-peer obtained media file. For example, the peer to peer file may be limited in the number of times it can be played. This kind of limit might typically allow between one and five plays on the file, although any number of plays between one and 8, for example, are possible. According to another embodiment, the user pays a different fee for a file that is encoded for a one-time play as compared with the file that is encoded for a multiple time play. In addition, the file may be set to automatically delete from the user's DVR hard drive or regular hard drive after the specified number of plays has been completed.

According to another aspect, the security device may allow the user to keep the file only a certain specified amount of time. For example, in one embodiment, the user can keep the file for two weeks before it is automatically deleted. In another embodiment, the user can keep the file only one week after the first viewing of the entire file. Security module may also prevent the file from being exported from the hard drive of the DVR in any manner other than peer to peer. For example, some programs, such as TiVo-to-go programs, allows certain files to be exported. Security controlled files may be prevented from this kind of export. Some DVR's may also include file encryption, so that no hacking program can surreptitiously access files which have been stored on the hard drive of the DVR. According to one aspect, an encryption process may be used to maintain the files on the hard drive as encrypted so that these files cannot be surreptitiously accessed.

Many conventional broadband internet systems allow faster and more extensive download than upload. This means that the peer to peer files may be completed downloading prior to reaching the desired ratio of upload to download. The embodiment allows the playing module in the DVR to play the media file while it is still being accessed by the peer to peer unit. One embodiment allows the playing module to access the file while it is still being uploaded. Another aspect divides the media file into sections, e.g., 3-6 sections. The first section to be played is downloaded first. Once that section is complete, it can be played. Other sections are downloaded, either simultaneously, or after completion of the first section download. This allows someone to watch a portion of the file sooner. The file breakup may be done by the tracker, or by the peer, which can choose specified file parts and call the parts making up the first section, e.g. 45 minutes of a media file, as a “section”.

Another embodiment allows playback of file parts that are complete, even while the same file is being downloaded. For example, the playback process may simply play only completed parts. Once the playback process reaches a part of the file which is not yet downloaded, the playback stops, and the viewer receives a message that they need to wait for more downloading. A bookmark, indicating the position where the playing ended, so that playing can later be “resumed”, may also be set at that time.

As another alternative, the TiVo service need not be the service that provides the peer-to-peer information. The peer-to-peer module can be a plug in is executed by the digital video recorder, which downloads the file information from some other service. The peer-to-peer service can also be an external unit, for example a device which clothes and to the USB or on the digital video recorder. In one aspect, that device may self-control the peer-to-peer downloading, and may include some storage area for example a 4 GB of storage to save the peer to peer information. Files stored in the external device can be interfaces with the DVR over its USB or network, and allow these vials either to be transferred or played on the digital video recorder. In one embodiment, the device may actually plug into software of the digital video recorder. However, another aspect requires no cooperation from the software of digital video recorder, but rather forms itself as a module which emulates a normal function of the digital video recorder in order to force the digital video recorder to play the information. For example, one aspect of current TiVo's is that they stream unit to unit. One aspect may allow the external device to emulate another tivo unit to allow such steaming.

Also, another embodiment contemplates a modified peer to peer system, where the peers upload and download files only until the downloading is complete. The central unit hence takes on the most uploading at any time, but the peers still do some uploading. An even further embodiment simply downloads from the central unit, with no peer to peer operations at all.

The general structure and techniques, and more specific embodiments which can be used to effect different ways of carrying out the more general goals are described herein.

Although only a few embodiments have been disclosed in detail above, other embodiments are possible and the inventor (s) intend these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art. For example, any device that has a DVR function, e.g., a computer with TV capabilities, or a stand alone TV, could be used in this way. While the above refers to the preferred peer to peer client as being a bittorrent client, it should be understood that any peer to peer client can be used, including proprietary peer-to-peer connections.

Also, the inventor intends that only those claims which use the words “means for” are intended to be interpreted under 35 USC 112, sixth paragraph. Moreover, no limitations from the specification are intended to be read into any claims, unless those limitations are expressly included in the claims. The computers described herein may be any kind of computer, either general purpose, or some specific purpose computer such as a workstation. The computer may be a Pentium class computer, running Windows XP or Linux, or may be a Macintosh computer. The computer may also be a handheld computer, such as a PDA, cellphone, or laptop.

The programs may be written in C, or Java, Brew or any other programming language. The programs may be resident on a storage medium, e.g., magnetic or optical, e.g. the computer hard drive, a removable disk or media such as a memory stick or SD media, or other removable medium. The programs may also be run over a network, for example, with a server or other machine sending signals to the local machine, which allows the local machine to carry out the operations described herein.

1. A system comprising
a video recorder having a television recording part which allows receiving of television programs, and recording of television programs as recorded program information, and having a storage area for program information which includes said recorded program information, and information about which programs are stored, and a playback module which allows selection of playback of a stored program, and plays back said stored program, where said storage area also stores upcoming program information indicative of programs which have not yet been recorded, and having a recording process which allows using said upcoming program information to record said programs, and said video recorder having a connection to a network which is publically available, over which said video recorder receives said upcoming program information,
and further comprising a peer-to-peer, program module, associated with said video recorder, and operating to allow media files to be downloaded and uploaded via said peer to-peer connection, and allowing said media files to be stored in said storage area, and uploaded from said storage area, and allowing information which has been downloaded via the peer-to-peer connection to be played by said playing module of the digital video recorder, said playing module is that digital video recorder also allowing playing of said programs which have been recorded using said upcoming program information.

2. A system as in claim 1, wherein said playback module allows a media file to be played while said peer-to-peer program module is still distributing said media file to multiple other peers.

3. A system as in claim 1, further comprising a file dividing process, which allows a specified portion of said file to be selected for download separate from other portions of the file, and which allows playing back the specified portion once that portion has been downloaded and while other said portions have not yet been downloaded.

4. A system as in claim 1, wherein said peer-to-peer module playback module allows uploading of files which have been marked as deleted.

5. A system as in claim 1, further comprising a selection part that accesses a list of media files that can be accessed via said peer-to-peer system via each of a plurality of different peers, and provides information indicative of said list to allow a peer to begin a file download.

6. A system as in claim 1, further comprising a selection part which enables selection of information related to a ratio between uploading and downloading of said peer-to-peer information.

7. A system as in claim 1, further comprising a security module in said digital video recorder which allows said media file obtained via said peer-to-peer connection to be played no more than a specified number of times, where that specified number of times is greater than one and less than unlimited.

8. A device as in claim 1, further comprising a security module in said digital video recorder, which prevents said media file obtained via said peer-to-peer connection from being sent outside said digital video recorder unit.

9. A method, comprising:
using a digital video recorder to connect to a network connection to obtain programming information for programs that are sent over a television carrying channel and to use said programming information to record at least one television carrying program;
allowing said digital video recorder to obtain files from plural different file sources using a peer-to-peer file transfer system over said network connection and to upload said files as downloaded from any of said plural different file sources to any of a second plurality of different file sources that include said plural different file sources; and
allowing playing of either said television carrying program or said peer-to-peer programs, using said digital video recorder.

10. A method as in claim 9, wherein said peer-to-peer module playback module allows said upload of files which have been marked as deleted.

11. A method as in claim 9, wherein said obtain program information comprises downloading program information which allows automatic determination of titles to be recorded using said digital video recorder, and wherein the program information also includes information about media files that can be obtained using the peer-to-peer file transfer system.

12. A method as claim 11, further comprising requesting one of said media files by selecting from a list of different available media files, and providing account information.

13. A method as in claim 12, further comprising maintaining a desired ratio between uploading and downloading of peer to peer files.

14. A method, comprising:
using a computer to select a media file for download using a peer-to-peer program;
determining a ratio between uploading and downloading on said computer; and
charging a fee for the download based on said ratio.

15. A method as in claim 14, wherein said computer is a digital video recorder, with a digital storage unit that stores off the air recorded programming, and also stores said media file obtained by said peer-to-peer program and includes a playing mechanism which allows playing either the broadcast information or the peer to peer collected information.

16. A method as in claim 15, wherein said playing mechanism defines different portions of the file, where a first portion of the file to be downloaded is the first portion of the file which will be played, and which downloads other sections of the file, and signals that the other sections can be played once the portion has been completely downloaded, even before the remaining portion of the file has been completely downloaded.

17. A method as in claim 16, further comprising marking a location where file playing has stopped, and allowing file playing to resume from a portion where the file playing has been read.

18. A method as in claim 14, further comprising executing a specified security aspect on files which have been downloaded, which prevents at least one action on said files.

19. A method as in claim 18, wherein said security aspect comprises causing said file to be deleted after a specified action.

20. A method as in claim 19, wherein said specified action comprises deleting the file after playing a specified number of times.

21. A method as in claim 14, wherein said peer-to-peer program allows said upload of files which have been marked as deleted
